(19) United States
(12) Patent Application Publication
(10) Pub. No.: US 2007/0126340 A1
(43) Pub. Date: Jun. 7, 2007

(54) Electrode arrangement of organic light emitting diode

(75) Inventors: Chin Chung Chang Chien, Chu-Nan (TW); Hui-Chang Yu, Chu-Nan (TW); Chih-Hung Wang, Chu-Nan (TW); Wei Ching Chang, Chu-Nan (TW)

Correspondence Address: BAKER & MCKENZIE LLP;PATENT DEPARTMENT, 2001 ROSS AVENUE, SUITE 2300, DALLAS, TX, 75201, US

(73) Assignee: Univision Technology Inc.

(21) Appl. No.: 11/292,521

(22) Filed: Dec. 2, 2005

(51) Int. Cl. H05B 33/06

(52) U.S. Cl. 313/500; 313/505; 313/503

(57) ABSTRACT

The present invention provides an electrode arrangement for an OLED display. The OLED display is controlled by a driving circuit. The electrode arrangement includes a plurality of first electrodes in a first direction and a plurality of second electrodes in a second direction. The first direction and the second direction are orthogonal. Each of the plurality of first electrodes includes a plurality set of concaves and convexes and two adjacent sets of the plurality sets of the convexes and concaves are engaged with each other. An overlap between the first electrode and the second electrode forms a light-emitting region of the OLED display.

### BACKGROUND OF THE INVENTION

1. Field of the Invention

The present invention generally relates to electrode and electrode lead arrangements of a light emitting device. More particularly, the present invention relates to electrode and electrode lead arrangement of an organic light emitting diode (OLED), where anode electrodes and cathode electrodes are electrically connected to a driving circuit through a plurality of anode and cathode leads.

2. Description of the Related Art

OLEDs are widely employed in flat panel displays due to their advantages of light weight, auto-emitting, wide viewing, high resolution, high brightness, low power consumption and high response velocity. However, their lifespan and the power consumption still need to be improved.

Conventionally, an OLED display, especially a display with a large panel resolution and a high resolution, needs a higher scan duty and a driving circuit that supplies a larger instant voltage. FIG. 1 shows a conventional OLED having a panel resolution of 128*160. The OLED display has a display region 12 and is divided into an upper portion 1 and a lower portion 2. The upper portion 1 of the display region 12 is controlled by a driving circuit IC 1 through first electrode leads 11 and a lower portion 2 of the display region 12 is controlled by a driving circuit IC 2 through second electrode leads 17.

FIGS. 2A-2C show conventional electrode lead arrangements, respectively. FIG. 2A is a diagram illustrating an anode with an anode lead arrangement, where a bottom end 10 of a transparent substrate 16 receives input signals from external circuits such as IC 1 or IC 2 of FIG. 1 and is orthogonal to the extension of a plurality of anode leads 18. The other ends of the anode leads 18 are connected to a plurality of anode electrodes 14. The anode electrodes 14 together form the display region 12. FIG. 2B is a diagram illustrating a cathode with a cathode lead arrangement, where a plurality of cathode leads 15 is each connected to a cathode electrode 13. FIG. 2C shows a combination of the structures shown in FIG. 2A and FIG. 2B, where the anode electrodes 14 and the cathode electrodes 13 intersect with each other within the display region 12 and their overlaps form light-emitting regions 19 or the so called pixels of the OLED. The cathode electrodes 13 intersect orthogonally to the anode electrodes 14 in the display region 12. The plurality of anode leads 18 and cathode leads 15 are both located at the bottom end 10 of the transparent substrate 16.

As all the pixels in the display region 12 are turn on, each of the cathode electrodes 13 or the cathode leads 15 sustains currents from the plurality of anode electrodes 14 transiently, resulting in the cathode electrodes 13 or the cathode leads 15 receiving more currents compared to the sum of the currents from the anode electrodes 14. At the same time, the conventional electrode and electrode lead arrangements induce higher resistances, inducing the most electrical power consumption on the electrodes and the electrode leads, thus requiring an increase in the supplied driving power.

FIG. 3 shows a circuit diagram of a conventional OLED display. Scan signals (S₁, S₂ . . . Sₘ) and data signals (D₁, D₂ . . . Dₙ) are transmitted to the cathode electrodes 13 and the anode electrodes 14 within the display region 12 through the plurality of cathode leads 15 and anode leads 18 in FIGS. 2A-2C. The OLED 191 in a display region 19 emits light according to the scan and data signals.

As can be seen from the figure, a conventional OLED display, especially one with a large area and a high resolution, would require a strong driving power due to its high scan duty, high instant current and high resistance. Therefore, a single driving circuit may not be able to drive a conventional OLED. At least two or more driving circuits may be necessary to drive the OLED. This requirement of additional driving circuits crate many disadvantages in a conventional OLED display. For example, it is more difficult to control their efficiencies when dealing with driving circuits. The bonding process is also more complex. There are also increased difficulties in writing programs and control signals. Thus, there is a need in the art for an improved OLED design that addresses the foregoing disadvantages.

### SUMMARY OF THE INVENTION

To achieve the foregoing and other objectives, and in accordance with the purposes of the present invention, as embodied and broadly described herein, the present invention provides an electrode arrangement for an OLED display, where only a single driving circuit is required.

In one aspect of the present invention, an electrode arrangement for an OLED display is provided. The OLED display is controlled by a driving circuit. The electrode arrangement includes at least one first electrode in a first direction and at least one second electrode in a second direction. The first direction and the second direction are orthogonal. The at least one first electrode comprises at least one set of concave and convex with the adjacent sets of the convexes and concaves being engaged with each other. The concaves and convexes are saw-toothed. The width of the second electrode is equal to a sum of a length of the concave and convex of the first electrode. The first electrode is anode and the second electrode is cathode. The anode is a transparent conductor selected from a group comprising of indium-tin oxide (ITO), indium-zinc oxide (IZO) and tin oxide. The cathodes are selected from a group comprising of Mo, Ag, Al, Cu, an alloy and a mixture thereof. An overlap between the first electrode and the second electrode forms a light-emitting region of the OLED display.

In one aspect of the present invention, an electrode arrangement for an OLED display is provided. The OLED display is controlled by a driving circuit. The electrode arrangement includes at least one first electrode in a first direction, at least one second electrode in a second direction and a at least one conductive line over the first electrode outside the light-emitting region. The first direction and the second direction are orthogonal. The at least one first electrode comprises at least one set of concave and convex with the adjacent sets of the convexes and concaves being engaged with each other. The concaves and convexes are saw-toothed. The width of the second electrode is equal to a sum of a length of the concave and convex of the first electrode. The first electrode is anode and the second electrode is cathode. The anode is a transparent conductor selected from a group comprising of indium-tin oxide (ITO), indium-zinc oxide (IZO) and tin oxide. The cathodes are selected from a group comprising of Mo, Ag, Al, Cu, an alloy and a mixture thereof. The conductive lines are selected from a group comprising of Mo, Ag, Al, Cu, an alloy and a mixture thereof. The conductive line may be narrower than the first electrode. The conductive line may either on one side of the light emitting region of the first electrode, or on more than one side of the light emitting region of the first electrode. The conductive line may further includes a plurality of segments alternatively formed on an outside of the concave and an outside of the convex of the first electrode. An overlap between the first electrode and the second electrode forms a light-emitting region of the OLED display.

In one aspect of the present invention, an electrode arrangement for a light emitting device is provided. The electrode arrangement includes at least two first electrodes capable of engaging with each other and at least one second electrode. An overlap between the first electrode and the second electrode forms a light-emitting region of the light emitting device.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention.

FIG. 1 shows a conventional OLED display having a panel resolution of 128*160 and being driven by two driving circuits.

FIGS. 2A-2C show conventional electrode lead arrangements.

FIG. 3 shows a circuit diagram of a conventional OLED display.

FIG. 4 shows an OLED display with a panel resolution of 128*160 size in accordance with the present invention.

FIGS. 5A-5C are diagrams illustrating electrode and electrode lead arrangements in accordance with one embodiment of the present invention.

FIGS. 6A-6C are diagrams illustrating electrode and electrode lead arrangements in accordance with another embodiment of the present invention.

FIG. 7 shows a top plane view of an OLED display in accordance with one embodiment of the present invention.

FIG. 8 shows a top plane view of an OLED display in accordance with another embodiment of the present invention.

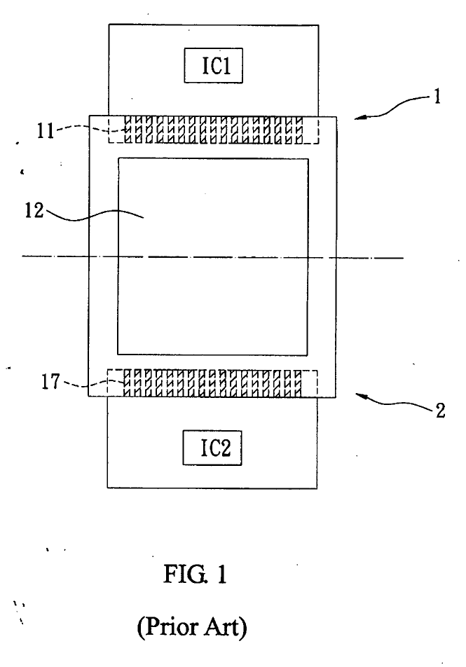

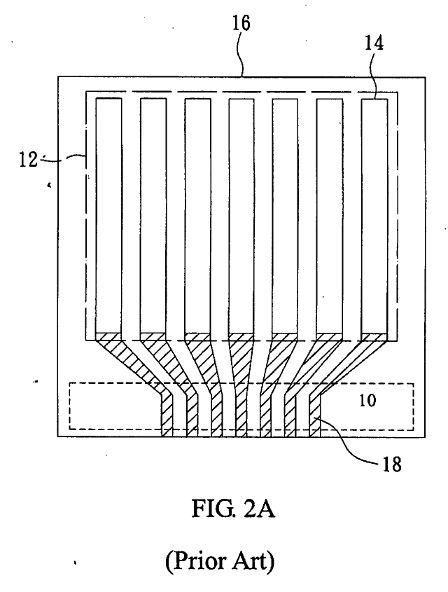

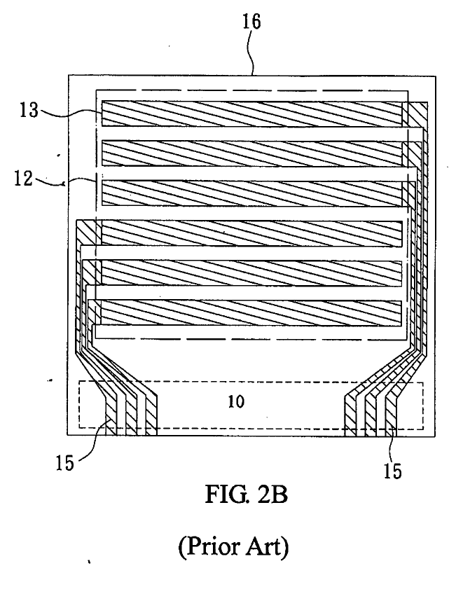

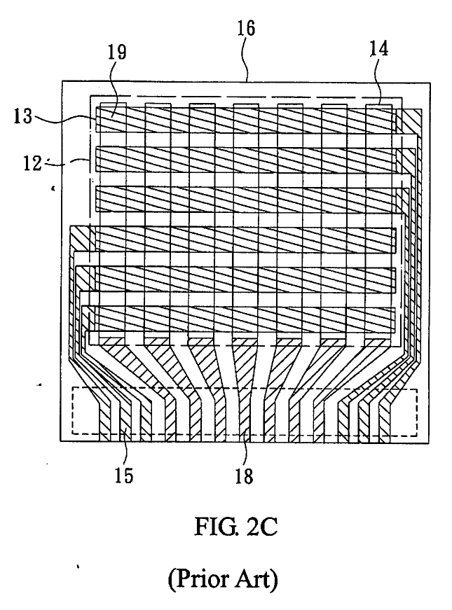

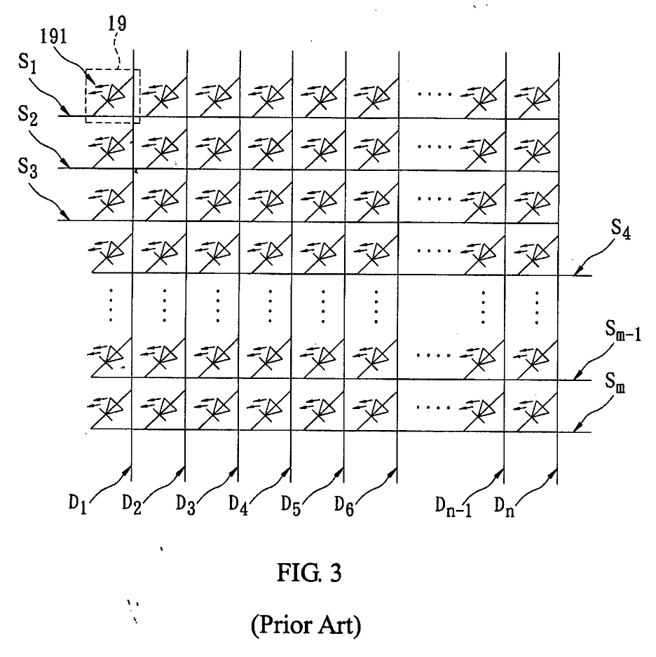

### DETAILED DESCRIPTION OF PREFERRED EMBODIMENTS

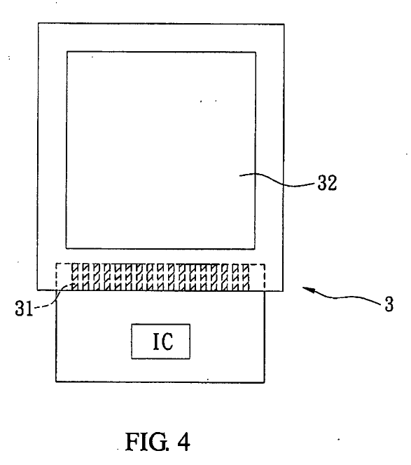

FIG. 4 shows an OLED display with a panel resolution of 128*160 pixels in accordance with the present invention. The OLED display 3 is controlled by a single driving circuit IC. A display region 32 of the OLED display 3 is driven by the driving circuit IC through a terminal 31.

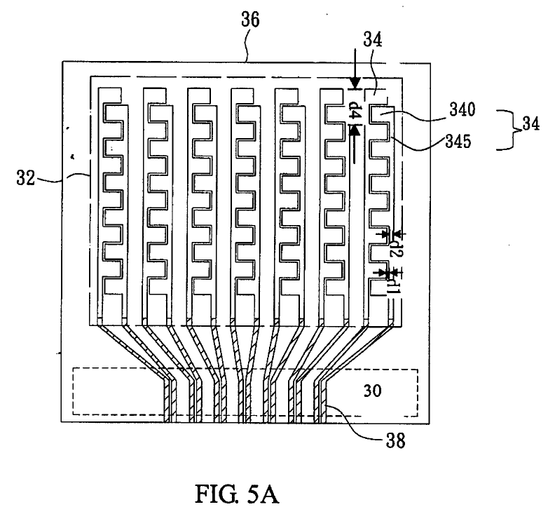

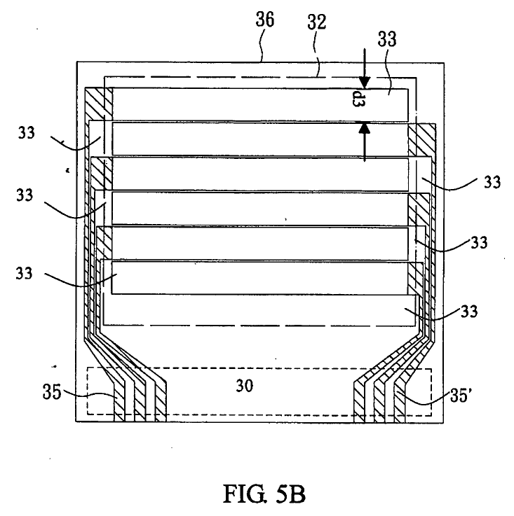

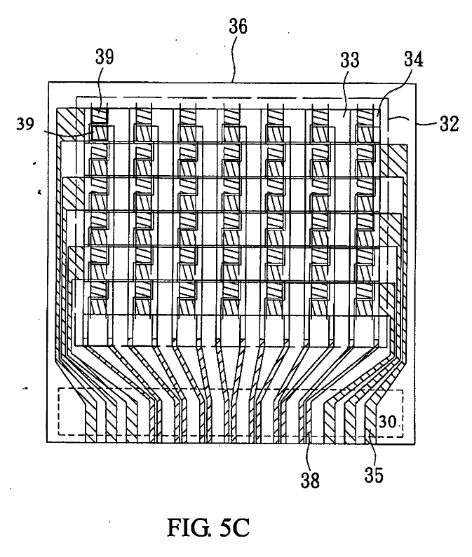

The OLED display of the present invention includes an anode layer and a cathode layer over the anode layer. Alternatively, the cathode layer may be located under the anode layer. The anode layer includes a plurality of anode electrodes 34, shown in FIG. 5A. The cathode layer includes a plurality of cathode electrodes 33, shown in FIG. 5B. FIGS. 5A-5C are diagrams of electrode and electrode lead arrangements in accordance with the present invention.

Specifically, FIG. 5A is a diagram illustrating an example of an anode electrode with an anode lead arrangement, where the bottom end 30 of a transparent substrate 36 serves as a terminal for receiving signals from driving circuit (not shown) according to a preferred embodiment of the present invention. The bottom end 30 of the transparent substrate 36 is orthogonal to a plurality of anode leads 38. The plurality of anode leads 38 are connected to the plurality of anode electrodes 34 and are dispersed over the bottom end 30 of the transparent substrate 36. The plurality of anode electrodes 34 are connected to the driving circuit (not shown) through the plurality of anode leads 38. The anode electrodes 34 in this embodiment are controlled by a single driving circuit through anode leads 38. In another embodiment, the anode electrodes 34 may be controlled by more than one driving circuits through anode leads 38. For example, the odd numbers of the plurality of anode electrodes 34 are controlled by one driving circuit, and the even numbers of the plurality of anode electrodes 34 may be controlled by another driving circuit. Meanwhile, the plurality of anode electrodes 34 together form a display region 32. The plurality of anode electrode 34 are designed as “dual scan,” meaning that the anode electrodes 34 includes a plurality sets of convexes 340 and concaves 345. Two adjacent convexes 340 and concaves 345 are engaged with each other. Such engagement could include a physical contact or without any contact between the convexes and concaves. In one preferred embodiment, the plurality of concaves 345 and the convexes 340 are saw-toothed as shown in FIG. 5A, but the present invention is not intended to limit the shape of the convexes 340 and concaves 345. Any shape is permissible, including triangular or square shaped. As exemplary dimensions of the present invention, the distance d1 between the convex 340 of one anode electrode 34 and the concave 345 of an adjacent anode electrode 34 is about 6 μm, the smaller part of the width d2 of the concave 345 is about 9 μm. In one embodiment, the anode electrode 34 is made of transparent material. Common transparent anode materials known to date include indium-tin oxide (ITO), indium-zinc oxide (IZO) and tin oxide, but other metal oxides may also be employed.

FIG. 5B is a diagram illustrating cathode electrodes and cathode lead arrangement, where a plurality of cathode leads 35 and 35′ are spaced at intervals over two sides of a transparent substrate 36 for connecting a plurality of cathode electrodes 33 respectively. Cathode leads 35 located on a left hand side of the transparent substrate 36 are connected to the odd numbers of the plurality of cathode electrodes 33, and cathode leads 35′ located on a right hand side of the transparent substrate 36 are connected to the even numbers of the plurality of cathode electrodes 33. The cathode electrodes 33 are connected to and being driven by the driving circuit (not shown) through the plurality of cathode leads 35 and 35′ respectively. The cathode electrodes 33 in this embodiment are controlled by a single driving circuit through cathode leads 35 and 35′. In another embodiment, the cathode electrodes 33 may be controlled by more than one driving circuits through cathode leads 35 and 35′ respectively. For example, the odd numbers of the plurality of cathode electrodes 33 may be controlled by one driving circuit, and the even numbers of the plurality of cathode electrodes 33 may be controlled by another driving circuit. The plurality of cathode electrodes 33 together form the display region 32. In one embodiment, the material of the cathode electrodes 33 may be low resistivity metals, such as Mo, Ag, Al, Cu, an alloy or a mixture of these metallic elements.

FIG. 5C shows a combination of the structures shown in FIG. 5A and FIG. 5B. The plurality of anode leads 38 and cathode leads 35 are both at the same bottom end 30 of the transparent substrate 36. The plurality of anode electrodes 34 and the plurality of cathode electrodes 33 intersect with each other in the display region 32. The plurality of cathode electrodes 33 intersect orthogonally to the plurality of anode electrodes 34. Overlaps between the plurality of anode electrodes 34 and the plurality of cathode electrodes 33 form light-emitting regions 39 or so called pixels of the OLED display. The light-emitting regions 39 or so called pixels of the OLED display are the areas emitting lights produced by the OLED. Specifically in this embodiment, one convex 340 from one anode electrode 34 overlaps with cathode electrode 33, and their overlap is the light-emitting region or so called one pixel 39, which is shown in FIG. 5C by bold lines. Two convexes 340 from two adjacent anode electrodes 34 would overlap with one cathode electrode 33 to form two pixels 39. The width d3 of the cathode electrode 33, shown in FIG. 5B, is the sum d4 of the convex 340 and concave 345, shown in FIG. 5A. In another embodiment, the convexes 340 from two adjacent anode electrodes 34 would overlap with two cathode electrodes 33. The plurality of cathode electrodes 33 and the plurality of anode electrodes 34 form the display region 32.

In accordance with the present invention, the scan duty is reduced. Specifically, as for a conventional OLED display with a panel resolution of 128*160 pixels, the scan duty is 128. In contrast, in accordance with the present invention, since two adjacent anode electrodes 34 are alternatively scanned, the scan duty is only one half of a conventional OLED display, merely 64.

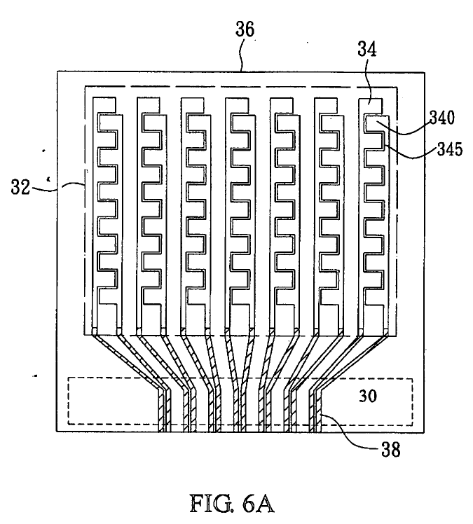

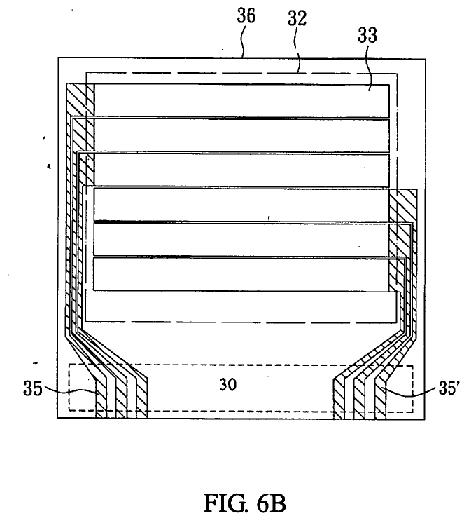

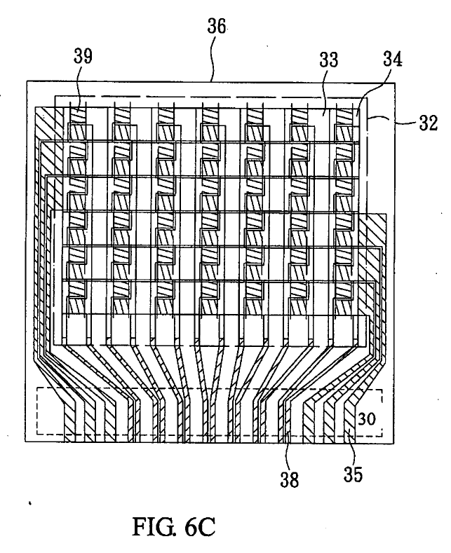

FIGS. 6A-6C are diagrams illustrating electrodes and electrode lead arrangements in accordance with another embodiment of the present invention. An anode electrode with an anode lead arrangement shown in FIG. 6A is similar to that shown in FIG. 5A, where the bottom end 30 of a transparent substrate 36 serves as a terminal for receiving signals from driving circuit (not shown). The bottom end 30 of the transparent substrate 36 is orthogonal to a plurality of anode leads 38. The plurality of anode leads 38 are connected to a plurality of anode electrodes 34 and are dispersed over the bottom end 30 of the transparent substrate 36. The plurality of anode electrodes 34 are connected to driving circuit (not shown) through the plurality of anode leads 38. The plurality of anode electrodes 34 include a plurality sets of convexes 340 and concaves 345. Adjacent sets of the convexes 340 and the concaves 345 are engaged with each other. In one preferred embodiment, the plurality of concaves 345 and convexes 340 are saw-toothed as shown in FIG, 6A. Meanwhile, the plurality of anode electrodes 34 form a display region 32. In one embodiment, the anode electrodes 34 are made of transparent material. Common transparent anode materials known to date include indium-tin oxide (ITO), indium-zinc oxide (IZO) and tin oxide, but other metal oxides may also be employed.

FIG. 6B is a diagram illustrating cathode electrodes and cathode lead arrangements, where a plurality of cathode leads 35 and 35′ are spaced at intervals over two sides of a transparent substrate 36 for connecting a plurality of cathode electrodes 33. In one embodiment, the cathode leads 35 located at a left hand side of the transparent substrate 36 are connected to a number of upper cathode electrodes 33, and the cathode leads 35′ located at a right hand side of the transparent substrate 36 are connected to a number of lower cathode electrodes 33. The upper and the lower cathode electrodes 33 may either be controlled by a single driving circuit or controlled by more than one driving circuits through cathode leads 35 and 35′ respectively. The plurality of cathode electrodes 33 together form the display region 32. In one embodiment, the material of the cathode electrodes 33 may be low resistivity metals, such as Mo, Ag, Al, Cu, an alloy or a mixture of these metallic elements.

FIG. 6C shows a combination of the structures shown in FIG. 6A and FIG. 6B, where the plurality of anode electrodes 34 and the plurality of cathode electrodes 33 intersect with each other in the display region 32 and their overlaps form light-emitting regions 39 or so called pixels of the OLED display. The light-emitting regions 39 or so called pixels of the OLED display are the areas emitting lights produced by the OLED. Specifically, one convex 340 from one anode electrode 34 overlaps one cathode electrode 33, and their overlap is the light-emitting region or so called one pixel 39. The plurality of cathode electrodes 33 and the plurality of anode electrodes 34 together form the display region 32.

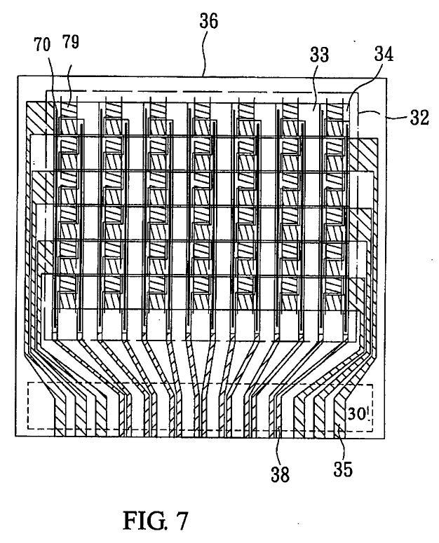

In one alternative embodiment, the OLED display further includes a conductive layer on the cathode layer surface. The conductive layer includes a plurality of conductive lines 70 as shown in FIG. 7. In one embodiment, the conductive lines 70 are formed outside the light-emitting regions 79 or so called pixels and are continuous lines extended from the plurality of anode leads 38. In a preferred embodiment, a conductive line 70 is narrower than a concave 345. The resistances of the electrodes are further reduced due to a low resistance of the conductive lines 70. The driving voltage required for the electrodes is therefore reduced, and only a single driving circuit is needed. Alternatively, the conductive lines are just on a selective number of anode leads 38 such as the even or add numbers. The material of the conductive lines 70 may be low resistivity metals, such as Mo, Ag, Al, Cu, an alloy or a mixture of these metallic elements.

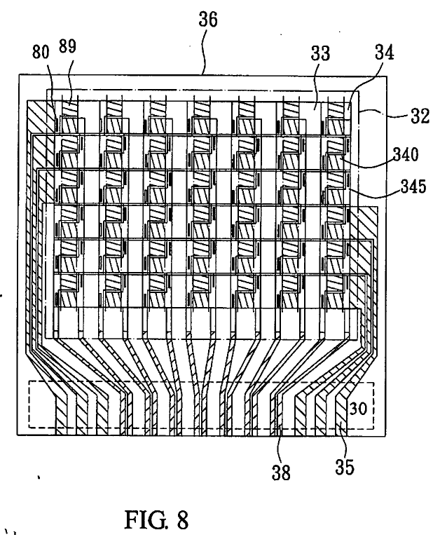

In another alternative embodiment, a plurality of conductive lines 80 included in the OLED display further includes a conductive layer on the cathode layer. The conductive layer includes a plurality of conductive lines as shown in FIG. 8. The conductive lines 80 are formed outside the light-emitting regions 89 or so called pixels and are discrete lines extended from the plurality of anode leads 38. The discrete lines 80 shown in FIG. 8 are formed merely over the concaves 345 without covering convexes 340 of the anode electrode 34. Since overlaps between convexes 340 the cathode electrode 33 forms the light-emitting regions 89 the conductive lines 80 formed over the concaves 345 do not block light emitting from the light-emitting regions 89, and thus the brightness of the OLED display is improved. The conductive lines 80 can be low resistivity metals, such as Mo, Ag, Al, Cu, an alloy or a mixture of these metallic elements, which will reduce the resistance of the electrodes.

Although the invention has been described with reference to the preferred embodiments, it will be understood that the invention is not limited to the details described herein. Substitutions and modifications have been suggested in the foregoing description, and others will occur to those of ordinary skills in the art. In particular, the process steps of the method in accordance with the invention will include methods having substantially the same process steps as the method of the invention to achieve substantially the same result. For example, the detailed description describes the present invention using OLED display as an example. Other light emitting devices may also utilize the present invention and are within the scope of the invention. Therefore, all such substitutions and modifications are intended to be within the scope of the invention as defined in the appended claims and their equivalents.

We claim:

1. An electrode arrangement for a light emitting device comprising:
at least one first electrode in a first direction, wherein the at least one first electrode comprises at least one set of concave and convex; and
at least one second electrode in a second direction;
wherein an overlap between said first electrode and said second electrode forms a light-emitting region of said light emitting device.

2. The electrode arrangement for a light emitting device of claim 1, wherein the convex and concave are engaged with each other.

3. The electrode arrangement for a light emitting device of claim 1, wherein said light emitting device comprises an organic light emitting diode (OLED).

4. The electrode arrangement for a light emitting device of claim 1, wherein said first electrode is anode and said second electrode is cathode.

5. The electrode arrangement for a light emitting device of claim 4, wherein said anode is a transparent conductor.

6. The electrode arrangement for a light emitting device of claim 4, wherein said cathode is selected from a group comprising of Mo, Ag, Al, Cu, an alloy and a mixture thereof.

7. The electrode arrangement for a light emitting device of claim 4, wherein said anode is selected from a group comprising of indium-tin oxide (ITO), indium-zinc oxide (IZO) and tin oxide.

8. The electrode arrangement for a light emitting device of claim 1, wherein said first direction and said second direction are orthogonal.

9. The electrode arrangement for a light emitting device of claim 1, wherein the concave and convex are saw-toothed.

10. The electrode arrangement for a light emitting device of claim 1, wherein a width of said second electrode is equal to a sum of a length of the concave and convex of said first electrode.

11. The electrode arrangement for a light emitting device of claim 1, further comprising at least one conductive line.

12. The electrode arrangement for a light emitting device of claim 11, wherein said conductive line is outside said light emitting region of said first electrode.

13. The electrode arrangement for a light emitting device of claim 11, wherein said conductive line is narrower than said first electrode.

14. The electrode arrangement for a light emitting device of claim 11, wherein said conductive line is on one side of said light emitting region of said first electrode.

15. The electrode arrangement for a light emitting device of claim 11, wherein said conductive line is on more than one side of said light emitting region of said first electrode.

16. The electrode arrangement for a light emitting device of claim 11, wherein said conductive line comprises a plurality of segments alternatively formed on an outside of said concave and an outside of said convex of said first electrode.

17. The electrode arrangement for a light emitting device of claim 11, wherein said conductive line is selected from a group comprising of Mo, Ag, Al, Cu, an alloy and a mixture thereof.

18. A light emitting display with only one driving circuit, comprising:
at least one first electrode in a first direction; and
at least one second electrode in a second direction;
wherein an overlap between said first electrode and said second electrode forms a light-emitting region of said OLED display.

19. An electrode arrangement for a light emitting device, comprising:
at least two first electrodes capable of engaging with each other; and
at least one second electrode;
wherein an overlap between said first electrode and said second electrode forms a light-emitting region of said light emitting device.

20. The electrode arrangement for a light emitting device of claim 19, further comprising at least one conductive line.
